(19) United States
(12) Patent Application Publication
(10) Pub. No.: US 2018/0306283 A1
(43) Pub. Date: Oct. 25, 2018

(54) DISC WITH INSERTABLE PINS AND METHOD OF MANUFACTURE FOR SAME

(71) Applicant: Fallbrook Intellectual Property Company LLC, Cedar Park, TX (US)

(72) Inventors: Dana J. Engesather, Bemidji, MN (US); John E. Hamrin, Bemidji, MN (US); Joel M. Dunlap, Bemidji, MN (US); Bruce H. Younggren, Bemidji, MN (US); Mike Selck, Detroit Lakes, MN (US); Bryan Mussetter, Princeton, MN (US); Bud Conklin, Princeton, MN (US); Dave Antonson, Grasston, MN (US); Gerald Dukart, Cambridge, MN (US)

(21) Appl. No.: 15/495,801

(22) Filed: Apr. 24, 2017

(51) Int. Cl. F16H 15/50; F16H 57/08

(52) U.S. Cl. CPC F16H 15/503; F16H 57/082

(57) ABSTRACT

A disc for controlling tilt angle for a plurality of axles in a ball planetary continuously variable transmission (CVT) is provided. A disc body is formed and pins are inserted to create slots. Each slot can be configured for contact with one end of an axle of a traction planet. The pins may be made from a different material or otherwise have different characteristics or properties than the disc body, allowing greater availability of materials that can be selected for forming the slots. The pins can be simple (such as a straight, cylindrical shape) or complex (including a complex curve of different diameters, multiple surfaces, and the like. A manufacturing process for a disc may include forming a disc body using a first process and then adding or removing material using a second process, then inserting pins into the disc body.

### BACKGROUND

### Field of the Disclosure

The field of the disclosure relates generally to continuously variable transmissions, and more particularly to components and methods for manufacturing continuously variable transmissions (CVTs).

### Description of the Related Art

Continuously variable transmissions (CVTs) are gaining popularity over traditional geared transmissions because CVTs achieve continuously variable ratios of input speed to output speed. In a CVT, a mechanism for adjusting the speed ratio of an output speed to an input speed may be referred to as a variator. In a belt-type CVT, a variator consists of two adjustable pulleys coupled by a belt. The variator in a single cavity toroidal-type CVT usually has two partially toroidal transmission discs rotating about a shaft and two or more disc-shaped power rollers rotating on respective axes that are perpendicular to the shaft and clamped between the input and output transmission discs. Usually, a control system is used for the variator so that the desired speed ratio can be achieved in operation.

Embodiments of a ball planetary type variator disclosed herein utilize planets (also known as speed adjusters, power adjusters, balls, planets, sphere gears, or rollers) that each has an axle defining a tiltable axis of rotation adapted to be adjusted to achieve a desired ratio of output speed to input speed during operation. An array of planets is angularly distributed in a plane perpendicular to a longitudinal axis of a CVT. The planets are interposed between an input disc and an output disc, and are positioned radially outward of an idler. The first disc (also referred to as an input disc) applies input torque at an input rotational speed to the planets. As each planet rotates about its own axis of rotation, the planets transmit power to the output disc. The output speed to input speed ratio is a function of the radii of the contact points of the input and output discs to the axes of the planets. Tilting the axles (and thus the axis of rotation) of the planets with respect to the axis of the variator adjusts the speed ratio or may be used to adjust a torque ratio.

### SUMMARY OF THE DISCLOSURE

The systems and methods herein described have several features, no single one of which is solely responsible for its desirable attributes. Without limiting the scope as expressed by the claims that follow, its more prominent features will now be discussed briefly. After considering this discussion, and particularly after reading the section entitled “Detailed Description of Certain Embodiments” one will understand how the features of the system and methods provide several advantages over traditional systems and methods.

A disc for controlling tilt angle for a plurality of axles in a ball planetary continuously variable transmission (CVT) is provided. A disc body is formed and pins are inserted to create slots. Each slot can be configured for contact with one end of an axle of a traction planet. The pins may be made from a different material or otherwise have different characteristics or properties than the disc body, allowing greater availability of materials that can be selected for forming the slots. The pins can be simple (such as a straight, cylindrical shape) or complex (including a complex curve of different diameters, multiple surfaces, and the like. A manufacturing process for a disc may include forming a disc body using a first process and then adding or removing material using a second process, then inserting pins into the disc body.

The use of insertable pins allows a high strength hard interface for planet axles to contact. The ability to form pins having different surfaces accommodates different axle ends.

A manufacturing process may include an inexpensive die casting with a single machining operation in a live-tool lathe.

A method of manufacturing a disc for a continuously variable transmission (CVT) having a plurality of traction planets is provided. Each traction planet has a tiltable axis of rotation. The method includes forming a disc from a material having a first set of properties, the disc including at least two sets of features. The method also includes machining, from a first feature in each set of features, a recess for retaining a first end of a pin. The method further includes machining, from a second feature in each set of features, a retaining feature for retaining a second end of a pin. The method includes positioning a pair of pins into the at least two sets of features, each pin formed from a second material having a second set of properties, the second set of properties being different than the first set of properties, wherein the pair of pins forms a slot.

A method of manufacturing a speed ratio adjusting mechanism for a continuously variable transmission (CVT) having a plurality of traction planets is provided. Each traction planet has an axle defining a tiltable axis of rotation. The method includes forming a disc from a material having a first set of properties, the disc including at least two sets of features. The method also includes forming a slot for an end of each axle. Forming the slot includes machining, from a first feature in each set of features, a recess for a first end of a pin; and machining, from a second feature in each set of features, a retaining feature for a second end of a pin. The method also includes forming a slot using a pair of pins, wherein forming the slot includes positioning the pair of pins into the at least two sets of features, each pin formed from a second material having a second set of properties, the second set of properties being different than the first set of properties.

A disc for a continuously variable transmission (CVT) having a plurality of traction planets is provided. Each traction planet has a tiltable axis of rotation. The disc includes a disc body formed from a material having a first set of properties. The disc body includes at least two sets of features, wherein a first feature in each set of features is configured for receiving a first end of a pin, and wherein a second feature in each set of features is configured for receiving a second end of a pin. The disc also includes a pair of pins, each pin formed from a second material having a second set of properties, each pin of the pair of pins being insertable into the first feature and the second feature of a set of features to form a slot.

A speed ratio adjusting mechanism for a continuously variable transmission (CVT) having a plurality of traction planets is provided. Each traction planet has an axle defining a tiltable axis of rotation. The speed ratio adjusting mechanism includes a first disc. The first disc includes a first disc body formed from a material having a first set of properties. The first disc also includes a first plurality of slots, each slot formed from at least two sets of features. The first disc further includes a first plurality of pins, wherein a first set of features is configured for receiving a first end of the first plurality of pins, and wherein a second set of features is configured for receiving a second end of the first plurality of pins. The speed ratio adjusting mechanism also includes a second disc. The second disc includes a second disc body formed from a material having a second set of properties. The second disc also includes a second plurality of slots, each slot formed from at least two sets of features. The second disc further includes a second plurality of pins, wherein a first set of features is configured for receiving a first end of the second plurality of pins, wherein a second set of features is configured for receiving a second end of the second plurality of pins. The speed ratio adjusting mechanism further includes an actuator for rotating the first disc relative to the second disc.

A continuously variable transmission (CVT) is provided. The CVT includes a plurality of traction planets, each traction planet having an axle defining a tiltable axis of rotation. The CVT also includes a speed ratio adjusting mechanism. The speed ratio adjusting mechanism includes a first disc. The first disc includes a first disc body formed from a material having a first set of properties. The first disc also includes a first plurality of slots, each slot formed from at least two sets of features. The first disc further includes a first plurality of pins, wherein a first set of features is configured for receiving a first end of the first plurality of pins, and wherein a second set of features is configured for receiving a second end of the first plurality of pins. The speed ratio adjusting mechanism also includes a second disc. The second disc includes a second disc body formed from a material having a second set of properties. The second disc also includes a second plurality of slots, each slot formed from at least two sets of features. The second disc further includes a second plurality of pins, wherein a first set of features is configured for receiving a first end of the second plurality of pins, and wherein a second set of features is configured for receiving a second end of the second plurality of pins. The speed ration adjusting mechanism further includes an actuator for rotating the first disc relative to the second disc.

### BRIEF DESCRIPTION OF THE DRAWINGS

A more complete understanding of embodiments and the advantages thereof may be acquired by referring to the following description, taken in conjunction with the accompanying drawings in which like reference numbers indicate like features and wherein:

FIG. 1 is a partial cutaway view of one embodiment of a CVT;

FIG. 2 is a perspective view of one embodiment of a disc body;

FIG. 3 is a partial perspective view of one embodiment of a disc body, illustrating a portion of a manufacturing process;

FIG. 4 is a partial perspective view of one embodiment of a disc body, illustrating a portion of a manufacturing process;

FIG. 5 is a partial perspective view of one embodiment of a disc body, illustrating a portion of a manufacturing process;

FIG. 6 is a perspective view of one embodiment of a pin;

FIGS. 7A and 7B are partial perspective views of one embodiment of a disc body, illustrating a portion of a manufacturing process;

FIG. 8 is a partial perspective view of one embodiment of a disc body, illustrating a portion of a manufacturing process; and

FIG. 9 is a partial perspective view of one embodiment of a speed ratio adjusting mechanism.

### DETAILED DESCRIPTION OF THE DISCLOSURE

The preferred embodiments will be described now with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, embodiments can include several features, no single one of which is solely responsible for its desirable attributes or which is essential to practicing embodiments described. Certain CVT embodiments described here are generally related to the type disclosed in U.S. Pat. Nos. 6,241,636; 6,419,608; 6,689,012; 7,011,600; 7,166,052; U.S. patent application Ser. Nos. 11/243,484 and 11/543,311; and Patent Cooperation Treaty Patent Application Nos. PCT/IB2006/054911 and PCT/US2007/023315. The entire disclosure of each of these patents and patent applications is hereby incorporated herein by reference.

It should be noted that reference herein to “traction” may include applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. For example, in the embodiment where a CVT is used for a bicycle application, the CVT can operate at times as a friction drive and at other times as a traction drive, depending on the torque and speed conditions present during operation.

Embodiments disclosed herein are related to the control of a variator and/or a CVT having spherical planets, each planet having an axle defining a tiltable axis of rotation that can be adjusted to achieve a desired ratio of input speed to output speed during operation. Adjustment of the axle—and therefore the axis of rotation—involves angular displacement (also referred to as misalignment) of the planet axis in one plane to achieve an angular adjustment of the planet axis of rotation in a second plane, thereby adjusting the speed ratio of the variator. The angular displacement (or misalignment) in the first plane is referred to herein as “skew” or “skew angle”. The angular adjustment in the second plane is referred to herein as “tilt” or “tilt angle.”

A control system coordinates the application of a skew angle to generate forces between certain contacting components in the variator that will tilt the planet axis of rotation. The tilting of the planet axis of rotation adjusts the speed ratio of the variator. Certain kinematic relationships between contacting components cause the planet axes of rotation to tilt in response to the application of a skew angle.

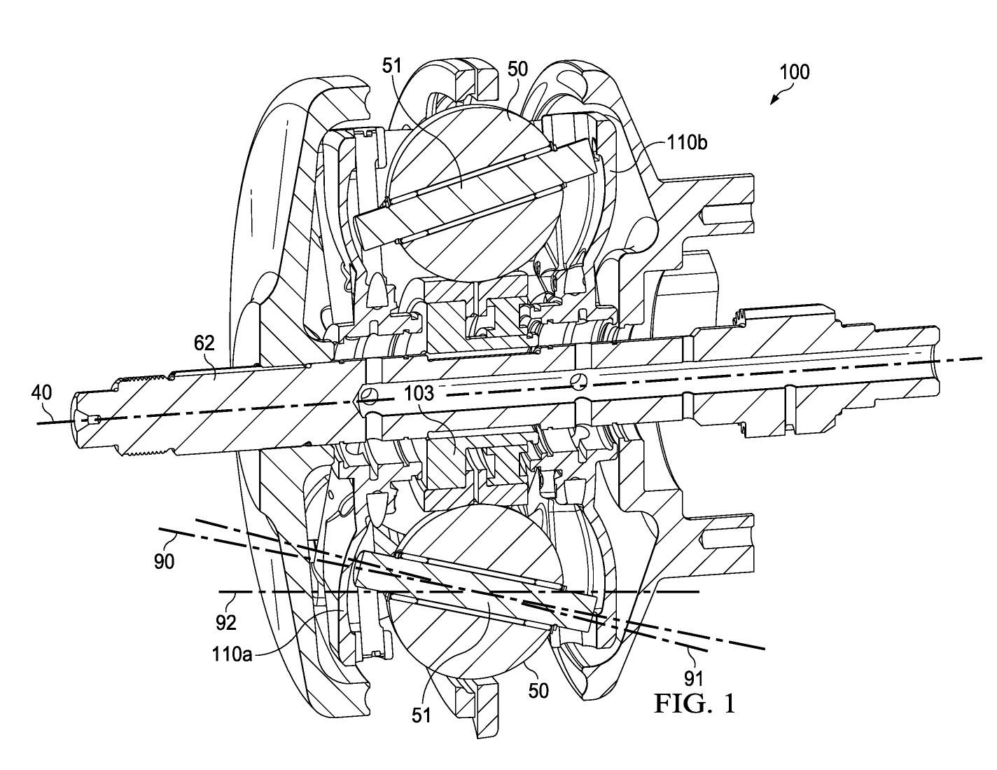

Embodiments disclosed herein may be generally directed to a variator for use in a continuously variable transmission (CVT) or infinitely variable transmission (IVT). As depicted in FIG. 1, variator 100 may include a plurality of planets 50 interposed between first and second traction rings (not shown) and arranged radially outward of sun 103 which is coaxial with shaft 62 defining longitudinal axis of rotation 40. Axles 51 extend through bores formed in planets 50. Axles 51 define axes of rotation 90. A first end of axles 51 may extend into first disc 110a and a second end of axles 51 may extend into second disc 110b.

Adjustment of a speed ratio of CVT 100 may be accomplished by adjustment of axles 51 (and therefore axes of rotation 90) for the plurality of planets 50. Adjustment of axles 51 may be accomplished via first disc 110a or second disc 110b. When axes of rotation 90 are parallel with longitudinal axis of rotation 40 (illustrated by line 92), the speed ratio for a CVT may be such that input speed and torque equal output speed and torque (minus frictional losses). When axes of rotation 90 are tilted relative to longitudinal axis of rotation 40, the speed ratio of a CVT may be such that input speed is higher than output speed, input speed is less than output speed, input torque is higher than output torque, or input torque is lower than output torque.

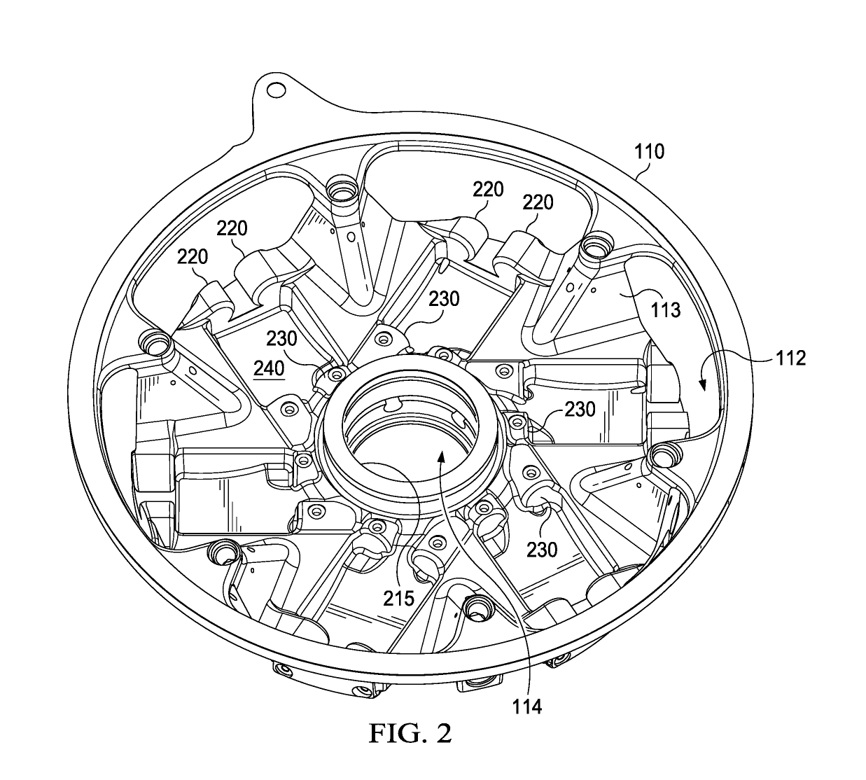

Generating a skew angle may be accomplished by rotation of one or both discs 110. Discs 110 have features for contact with axles 51 and main shaft 62, and may include features for interaction or coupling with other elements as needed. As depicted in FIG. 2, disc 110 (which may form all or a portion of first disc 110a or second disc 110b) may be formed with central bore 114 for positioning around shaft 62, openings 112, and struts 113 or other features to accommodate other elements of CVT 100. Disc 110 may be formed from a single material or an alloy, and may be formed using one or more machining processes. In some embodiments, a machining process may include casting, material deposition, 3-D printing or other process in which material is added to form disc 110. In some embodiments, a machining process may involve milling, drilling, boring, cutting, or some other material removal process to form disc 110. Furthermore, a portion of disc 110 may be formed using a first process in which material is added and a second process in which material is removed, or vice versa. The determination of which manufacturing process is used to form disc 110 may depend on a desired set of characteristics. Hardness, flexibility, stiffness, durability, resistance (chemical, electrical, thermal, magnetic, etc.) or conductance (chemical, electrical, thermal, magnetic, etc.), ferrous, non-ferrous, weight and density are all examples of characteristics which may determine what material or materials (including alloys) may be used to form disc 110 or portions of disc 110. For example, surface 215 of central bore 114 may be desired to have a low friction coefficient, surface 240 may be desired to have a thermal coefficient to enable faster heat dissipation, strut 113 may be desired to provide a desired stiffness, or disc 110 may be desired to have some overall characteristic such as electrical conductance, corrosion resistance, etc. Disc 110 may also be formed with features 220, 230 for coupling to other elements of CVT 100.

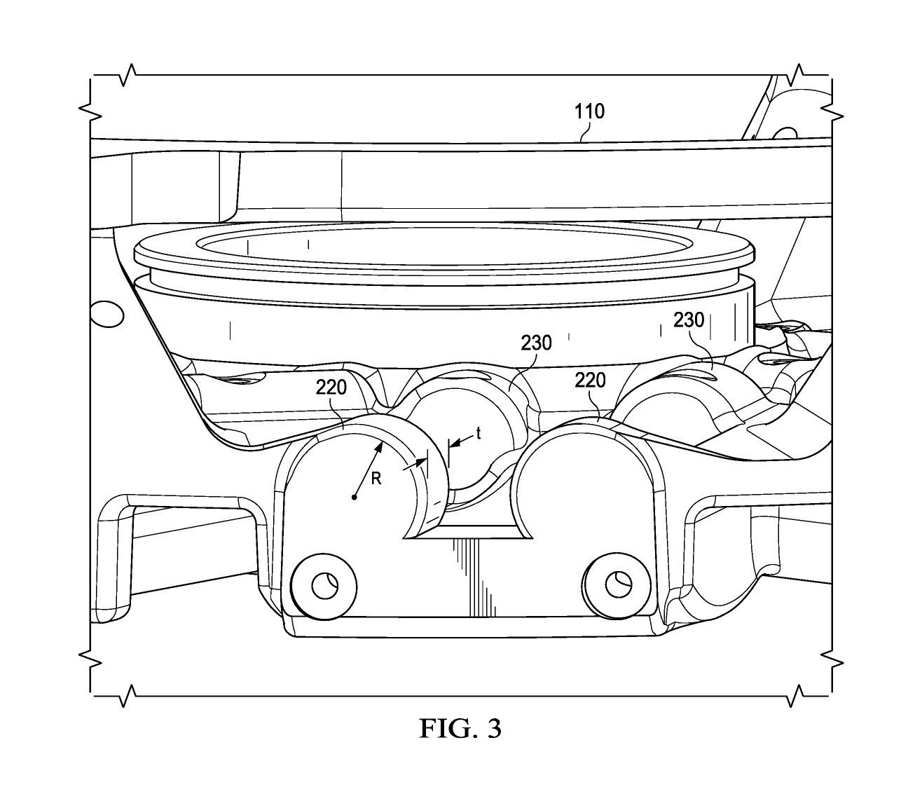

A manufacturing process may be performed in steps or stages. For example, a first stage may involve casting a part. A second step may involve machining parts from the part formed in the first stage. FIG. 3 depicts a partial perspective view of one embodiment of disc 110, which may be formed to have features which may then be machined to form selected features. In FIG. 3, features 220 and 230 may be formed in a first manufacturing stage. Features 220 and 230 may be formed with an initial thickness, radius, convexity, concavity, length, width, angle, curvature or other dimension or combination of dimensions.

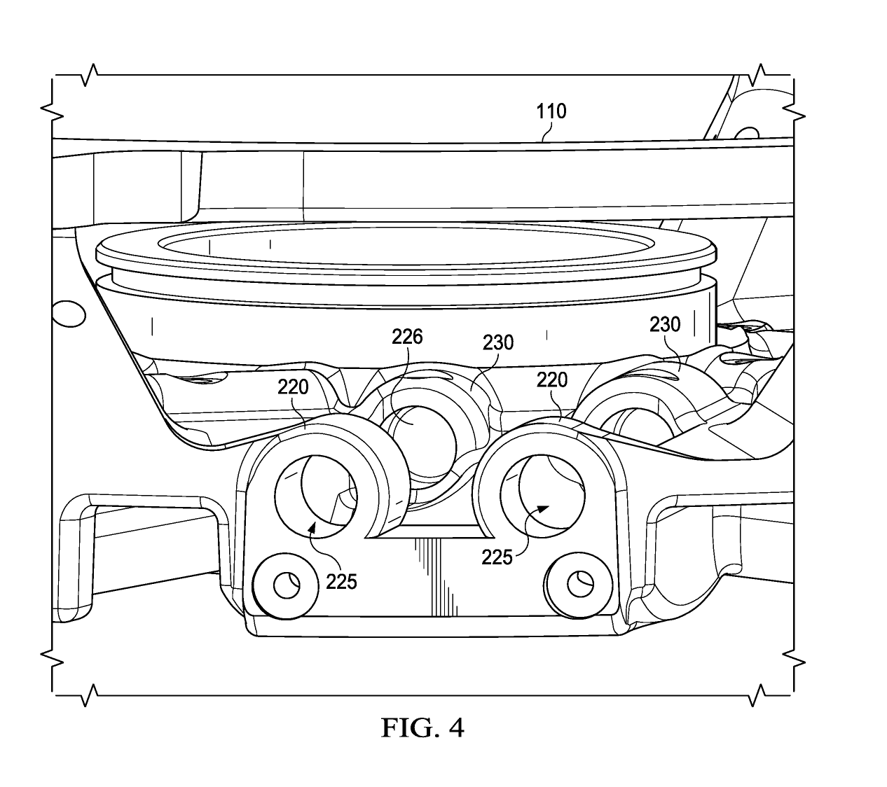

FIG. 4 depicts a partial perspective view of one embodiment of disc 110, which may be cast or otherwise formed to have features which may then be machined to form selected features. As depicted in FIG. 4, features 220 and 230 are machined to form openings 225 and recesses 226, respectively. Openings 225 and/or recesses 226 may be formed by reaming, milling, drilling, cutting, boring or some other material removal process.

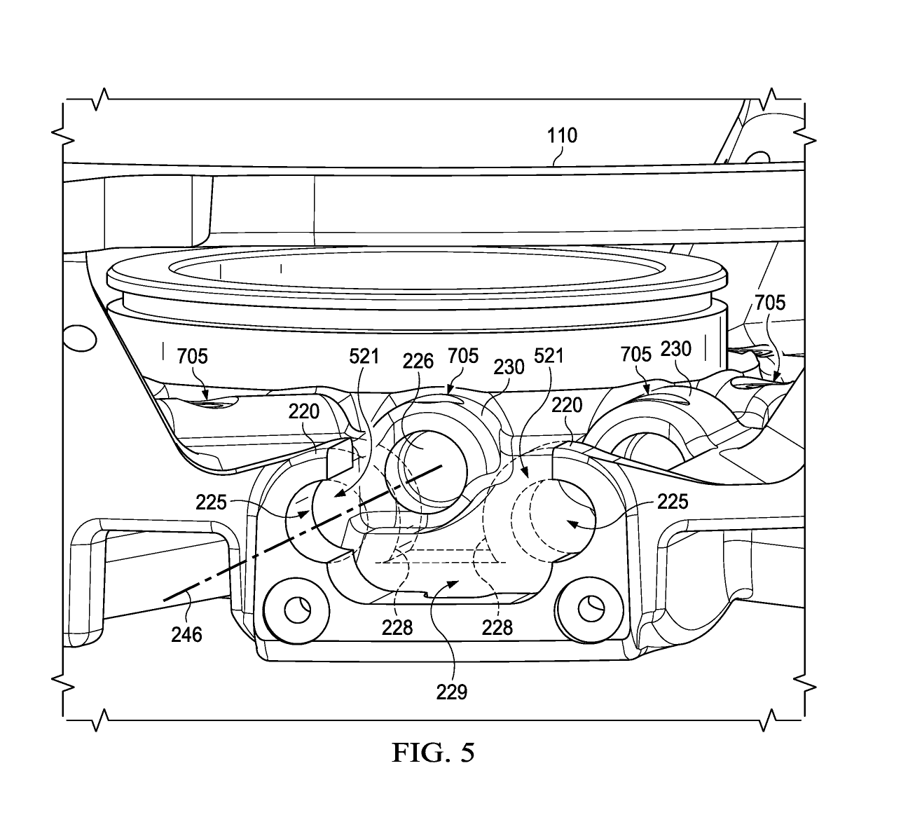

In some embodiments, a stage in a manufacturing process may include multiple steps. FIG. 5 depicts a partial perspective view of one embodiment of disc 110, illustrating features which may be formed using multiple steps. In some embodiments, a retaining feature may be formed from a combination of machining processes. A first step may include casting features 220 and 230. A second step may include machining openings 225 in features 220 and machining recesses 226 in features 230. Openings 225 or recesses 226 may be formed as through bores. A third step may include forming a thread inside opening 705. A fourth step may include cutting or otherwise removing material 228 to form cutouts 521 and/or passage 229. Those skilled in the art will appreciate that variations in the order of steps may be possible without affecting the scope of this disclosure or the appearance or functionality of disc 110. Furthermore, there may be intermediate steps performed as well. For example, the step of machining openings 225 in features 220 and machining recesses 226 in features 230 may be performed as a single step, with a single drill bit advancing along line 246 through feature 220 and to a desired depth in feature 230. Alternatively, the step of machining openings 225 in features 220 and machining recesses 226 in features 230 may be performed in multiple steps, in which a first drill bit is used to machine opening 225 in feature 220, the drill bit is replaced with a second drill bit and the second drill bit is advanced into feature 230 to form recess 226. Using two drill bits of different sizes may ensure the second drill bit does not contact feature 220 which could affect the alignment of recess 226 relative to line 246 or opening 225.

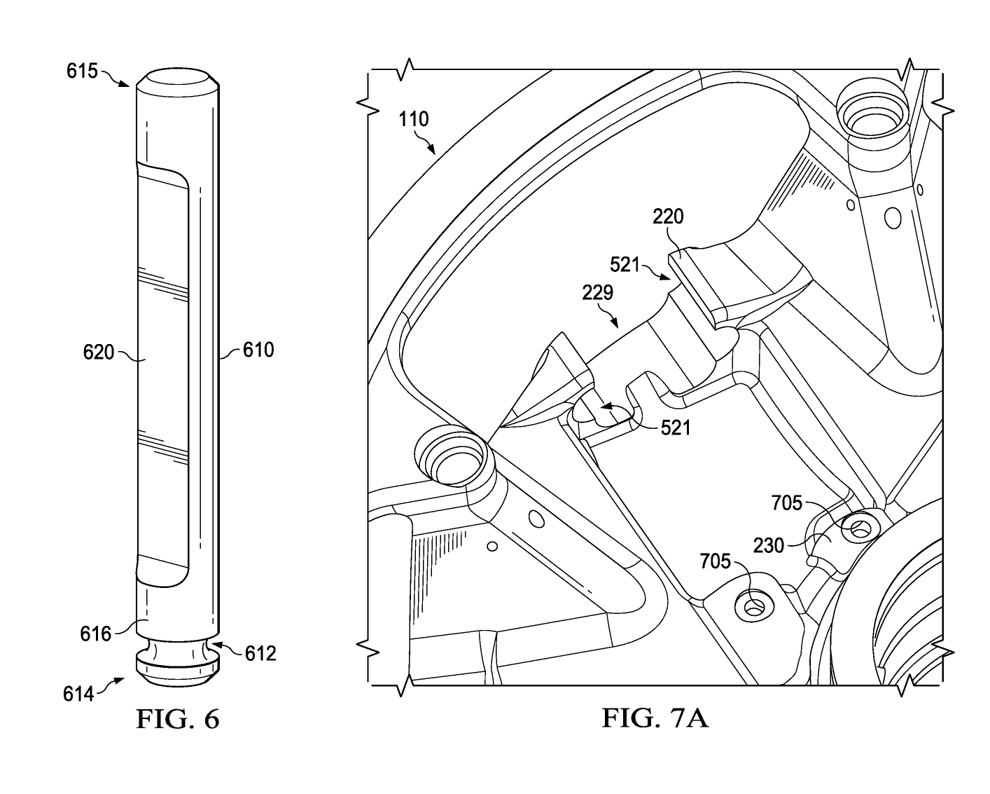

Disc 110 may be manufactured with additional elements based on desired characteristics. FIG. 6 depicts a perspective view of one embodiment of pin 610 formed from a material selected for a desired characteristic. Hardness, flexibility, stiffness, durability, resistance (chemical, electrical, thermal, magnetic, etc.) or conductance (chemical, electrical, thermal, magnetic, etc.), ferrous, non-ferrous, weight and density are all examples of characteristics which may determine what material or materials (including alloys) may be used to form pin 610. Pin 610 may be formed with features, including axial features, radial features, circumferential features, or the like. For example, pin 610 may be formed with circumferential groove 612, lip 614, chamfer 615, circumferential surface 616, machined surface 620, or the like. Other circumferential features of pin 610 may allow or prevent additional degrees of freedom. In some embodiments, features may be formed to facilitate assembly or removal, allow rotation or translation, allow for adjustment of an installed pin 610, or some other desired characteristic or function of pin 610.

Surfaces 616 or 620 are formed for contact with ends of axles 51, interaction with retaining features (discussed below) or contact with other elements. For example, pin 610 may be formed with a circular cross section and axle ends 51 may be cylindrical, or pin 610 may be formed with flat surface 620 and axle ends 51 may be spherical. Those skilled in the art will appreciate after reading this disclosure that other variations are possible, which can be selected to reduce contact stress, increase life, etc.

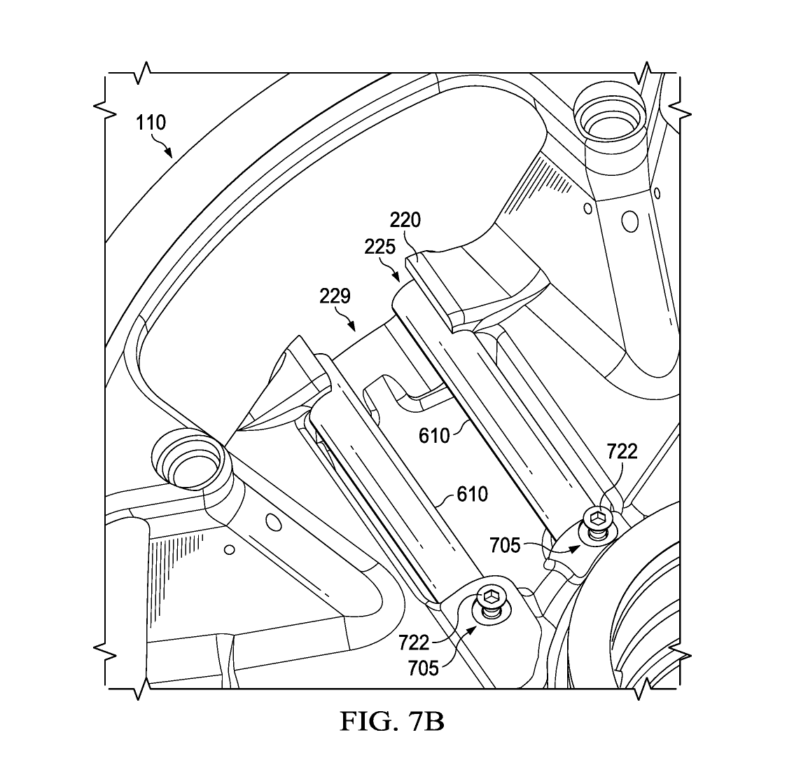

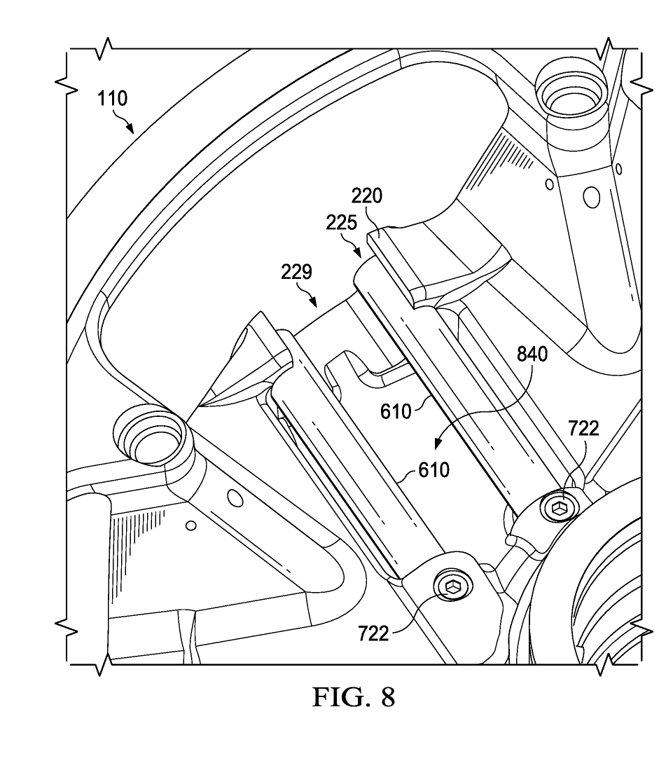

Manufacturing disc 110 may include inserting pins 610 having desired characteristics into features formed on disc 110. FIGS. 7A and 7B depict partial perspective views of disc 110, illustrating a portion of one embodiment of a manufacturing process. In FIG. 7A, disc 110 has been formed with retaining features 521 and passage 229 formed. In FIG. 7B, first ends of pins 610 are positioned in recesses 226 (not visible) and secured by hardware 722, and second ends of pins 610 are positioned in retaining features 521. Retaining pins 610 may include mechanical, thermal or chemical means. For example, positioning or retaining of second ends of pins 610 may include an interference fit in retaining features 521. Screws, rivets, welding, soldering, the use of dissimilar metals, epoxies and glues are all examples of mechanical, thermal and chemical means which may be used to retain (permanently or removably) pins 610 in retaining features 521. In some embodiments, pins 610 may be formed with a higher hardness rating than disc 110. This difference in hardness may have a corresponding difference in thermal expansion coefficients between pin 610 and disc 110. In these cases, the use of hardware 722 may be necessary. However, in other embodiments, the coefficients of thermal expansion may be low enough such that hardware 722 is not necessary. FIG. 8 depicts a partial perspective view, illustrating disc 110 with pins 610 having a first end held in place by hardware 229 such that an angle or width 840 is formed between pins 610.

As used here, the phrase “skew condition” refers to an arrangement of the planet axis 51 relative to the longitudinal axis of rotation 40 such that a non-zero skew angle exists. Hence, reference to “inducement of a skew condition” implies an inducement of planet axes 51 to align at a non-zero skew angle. It should be noted that in certain embodiments of CVT 100 certain spin-induced forces also act on planets 50.

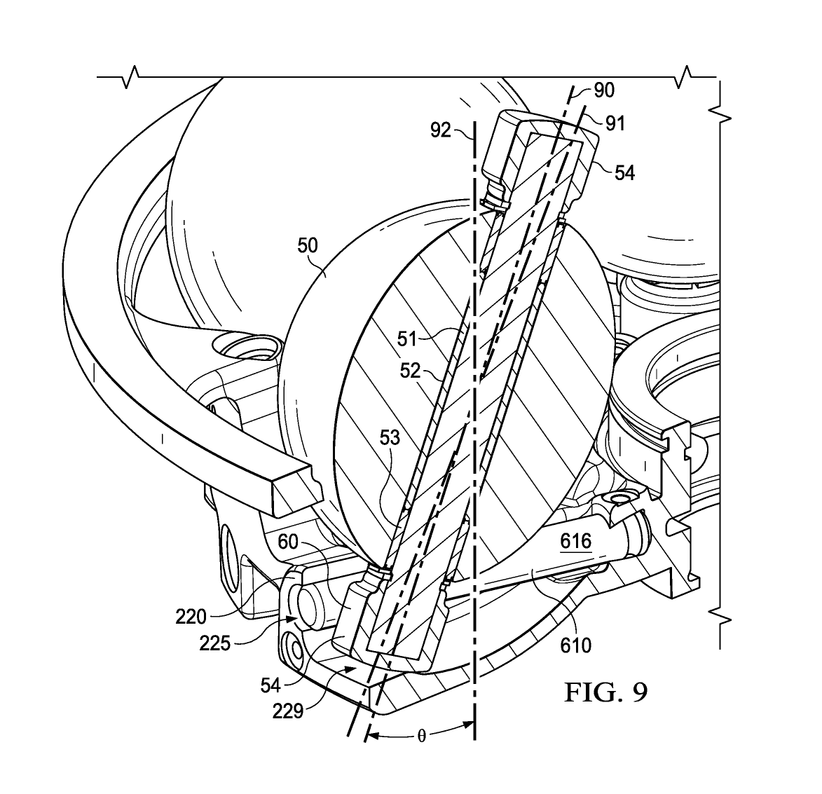

As depicted in FIGS. 7B and 9, ends of axles 51 are capable of curvilinear translation in slots formed by a pair of pins 610. An effect of this bias is that axis 90 tilts to line 91 oriented at angle theta relative to line 92 (which runs parallel to longitudinal axis of rotation 40, illustrated in FIG. 1). Speed ratio adjusting mechanism allows axle 51 to return to a stable equilibrium, which may be defined by axis 90 aligning with line 92.

During operation of the CVT 500, disc 110a or disc 110b can be rotated to an angular displacement via a control input. FIG. 9 depicts is a partial perspective view of one embodiment of a speed ratio adjusting mechanism, illustrating how pins 610 may be used to control translation of axles 51. As disc 110a or 110b rotates about longitudinal axis of rotation 40 (counterclockwise when viewed from above), surface 616 of pin 610 contacts axle 51, causing an angular or radial displacement of the end of axle 51. An angular displacement induces a skew angle on planet axles 51. The skew angle motivates a change in the tilt angle (theta) of planet axles 51. A radial displacement causes a change in tilt angle (theta) of planet axles 51. As planet axles 51 tilt, the ends of planet axles 51 translate along slots formed by pins 610. Slots formed by pins 610 may be configured so that the skew angle decreases in magnitude as planet axles 51 tilt towards an equilibrium condition. An equilibrium condition may correspond to a zero-skew angle condition. Once planet axles 51 reach a desired tilt angle, which generally coincides with a zero-skew angle condition, the tilting of planet axles 51 stops.

Slots formed by pins 610 have a width sized to accommodate the outer diameter of axle 51, including any endcap 54 or other feature. In some embodiments, slots formed on disc 110a may be arranged so that radially offset slots formed on disc 110b do not align (that is, are radially or angularly offset) with slots formed on disc 110a. The width and offset of slots on disc 110b depend on a desired response of CVT 100. For example, a desired response of CVT 100 may be relatively quick. In these cases, an offset angle may be higher (e.g., greater than 10 degrees, greater than 20 degrees, etc.) and a width between pins 610 may be increased as well. If a desired response is to be slower to provide a more stable system, an offset angle may be lower (e.g., less than 10 degrees, less than 5 degrees, etc.) and a width 840 between pins 610 may be less as well.

Alternatively, offset slots may be formed using pins 610 to have an angular offset relative to a line with respect to a diameter of disc 110. In some embodiments, an angular offset is in the range of 3 degrees to 45 degrees. In some embodiments, the angular offset can be between 5 and 20 degrees.

Axle 51 may be formed from a single material or may be formed from multiple parts. For example, axle 51 may include endcaps 54, sleeve 52 or bearings 53, which may be formed from the same material as axle 51 or may be formed for a particular characteristic or profile.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the term “coupled,” refers to a relationship (mechanical, linkage, coupling, etc.) between elements. A coupling between two elements may be exist whereby operation of one element results in a corresponding, following, or simultaneous operation or actuation of a second element. Unless otherwise specifically stated, the term indicates that the actual linkage or coupling may take a variety of forms.

As used herein, the term “radial” is used to indicate a direction or position that is perpendicular relative to a longitudinal axis of a transmission or variator. The term “axial” as used herein refers to a direction or position along an axis that is parallel to a main or longitudinal axis of a transmission or variator. For clarity and conciseness, at times similar components labeled similarly (for example, disc 110a and disc 110b) may be referred to collectively by a single label (for example, disc 110).

It should be noted that the description above has provided dimensions for certain components or subassemblies. The mentioned dimensions, or ranges of dimensions, are provided in order to comply as best as possible with certain legal requirements, such as best mode. However, the scope described herein are to be determined solely by the language of the claims, and consequently, none of the mentioned dimensions is to be considered limiting on the embodiments, except in so far as any one claim makes a specified dimension, or range of thereof, a feature of the claim.

The foregoing description details certain embodiments. It will be appreciated, however, that no matter how detailed the foregoing appears in text, variations in embodiments may be practiced without deviating from the disclosure. As is also stated above, it should be noted that the use of particular terminology when describing certain features or aspects should not be taken to imply that the terminology is being re-defined herein to be restricted to including any specific characteristics of the features or aspects with which that terminology is associated.

What is claimed is:

1. A method of manufacturing a disc for a continuously variable transmission (CVT) having a plurality of traction planets, each traction planet having a tiltable axis of rotation, the method comprising:
forming a disc from a material having a first set of properties, the disc including at least two sets of features;
machining, from a first feature in each set of features, a recess for retaining a first end of a pin;
machining, from a second feature in each set of features, a retaining feature for retaining a second end of a pin; and
positioning a pair of pins into the at least two sets of features, each pin formed from a second material having a second set of properties, the second set of properties being different than the first set of properties, wherein the pair of pins forms a slot.

2. The method of claim 1, wherein the slot is aligned parallel to a radial line that is perpendicular to a longitudinal axis of the continuously variable transmission.

3. The method of claim 1, wherein the slot is angled or curved relative to a radial line that is perpendicular to a longitudinal axis of the continuously variable transmission.

4. The method of claim 1, wherein forming the disc comprises a casting process.

5. The method of claim 1, wherein positioning a pin of the pair of pins comprises press fitting the pin into the first feature and the second feature of a set of features.

6. The method of claim 1, wherein a coupling between a pin of the pair of pins and a set of features is configured to allow rotation of the pin about a longitudinal axis of the pin.

7. A method of manufacturing a speed ratio adjusting mechanism for a continuously variable transmission (CVT) having a plurality of traction planets, each traction planet having an axle defining a tiltable axis of rotation, the method comprising:
forming a disc from a material having a first set of properties, the disc including at least two sets of features;
forming a slot for an end of each axle, wherein forming the slot comprises:
machining, from a first feature in each set of features, a recess for a first end of a pin; and
machining, from a second feature in each set of features, a retaining feature for a second end of a pin; and
forming a slot using a pair of pins, wherein forming the slot comprises positioning the pair of pins into the at least two sets of features, each pin formed from a second material having a second set of properties, the second set of properties being different than the first set of properties.

8. The method of claim 7, wherein the slot is aligned with a radial line that is perpendicular to a longitudinal axis of the continuously variable transmission.

9. The method of claim 7, wherein the slot is angled, curved or offset relative to a radial line that is perpendicular to a longitudinal axis of the continuously variable transmission.

10. A disc for a continuously variable transmission (CVT) having a plurality of traction planets, each traction planet having a tiltable axis of rotation, comprising:
a disc body formed from a material having a first set of properties, the disc body including at least two sets of features, wherein a first feature in each set of features is configured for receiving a first end of a pin, and wherein a second feature in each set of features is configured for receiving a second end of a pin; and
a pair of pins, each pin formed from a second material having a second set of properties, each pin of the pair of pins being insertable into the first feature and the second feature of a set of features to form a slot.

11. The disc of claim 10, wherein the second set of properties comprises a hardness of the second material.

12. The disc of claim 11, wherein the second material is the same material as the first material.

13. The disc of claim 10, wherein each set of features comprises an opening.

14. The disc of claim 13, wherein the opening comprises a through bore.

15. The disc of claim 10, wherein the disc body is formed by a casting process.

16. The disc of claim 10, wherein a pin of the pair of pins is press fit into the first feature and the second feature of a set of features.

17. The disc of claim 10, wherein the slot is aligned with a radial line that is perpendicular to a longitudinal axis of the continuously variable transmission.

18. The disc of claim 10, wherein the slot is angled, curved or offset relative to a radial line that is perpendicular to a longitudinal axis of the continuously variable transmission.

19. The disc of claim 10, wherein a pin of the pair of pins is coupled to a set of features, and wherein the coupling between the pin and the set of features is configured to allow rotation of the pin about a longitudinal axis of the pin.

20. The disc of claim 10, wherein a pin of the pair of pins is coupled to a set of features, and wherein the coupling between the pin and the set of features is fixed against rotation of the pin about a longitudinal axis of the pin.

21. A speed ratio adjusting mechanism for a continuously variable transmission (CVT) having a plurality of traction planets, each traction planet having an axle defining a tiltable axis of rotation, the speed ratio adjusting mechanism comprising:
a first disc comprising
a first disc body formed from a material having a first set of properties, the first disc including a first plurality of slots, each slot formed from at least two sets of features; and
a first plurality of pins, wherein a first set of features is configured for receiving a first end of the first plurality of pins, wherein a second set of features is configured for receiving a second end of the first plurality of pins;
a second disc comprising a second disc body formed from a material having a second set of properties, the second disc including a second plurality of slots, each slot formed from at least two sets of features; and
a second plurality of pins, wherein a first set of features is configured for receiving a first end of the second plurality of pins, wherein a second set of features is configured for receiving a second end of the second plurality of pins; and
an actuator for rotating the first disc relative to the second disc.

22. The speed ratio adjusting mechanism of claim 21, further comprising an axle of a traction planet formed having a third set of properties, wherein each slot of the first plurality of slots is configured for contact with one end of the axle.

23. The speed ratio adjusting mechanism of claim 21, wherein at least one slot is aligned with a radial line that is perpendicular to a longitudinal axis of the continuously variable transmission.

24. The speed ratio adjusting mechanism of claim 21, wherein at least one slot is angled, curved or offset relative to a radial line that is perpendicular to a longitudinal axis of the continuously variable transmission.

25. The speed ratio adjusting mechanism of claim 21, further comprising an axle of a traction planet, wherein a first end of the axle is cylindrical.

26. The speed ratio adjusting mechanism of claim 21, further comprising an axle of a traction planet, wherein a first end of the axle is spherical.

27. The speed ratio adjusting mechanism of claim 21, further comprising an axle of a traction planet, wherein a diameter of a first end of the axle is greater than a diameter of at least one pin.

28. A continuously variable transmission (CVT) comprising:
a plurality of traction planets, each traction planet having an axle defining a tiltable axis of rotation; and
a speed ratio adjusting mechanism comprising:
a first disc comprising
a first disc body formed from a material having a first set of properties, the first disc including a first plurality of slots, each slot formed from at least two sets of features; and
a first plurality of pins, wherein a first set of features is configured for receiving a first end of the first plurality of pins, wherein a second set of features is configured for receiving a second end of the first plurality of pins;
a second disc comprising
a second disc body formed from a material having a second set of properties, the second disc including a second plurality of slots, each slot formed from at least two sets of features; and
a second plurality of pins, wherein a first set of features is configured for receiving a first end of the second plurality of pins, wherein a second set of features is configured for receiving a second end of the second plurality of pins; and
an actuator for rotating the first disc relative to the second disc.

29. The CVT of claim 28, wherein at least one slot is aligned with a radial line that is perpendicular to a longitudinal axis of the continuously variable transmission.

30. The CVT of claim 28, wherein at least one slot is angled, curved or offset relative to a radial line that is perpendicular to a longitudinal axis of the continuously variable transmission.

31. The CVT of claim 28, wherein the first end of the axle is cylindrical.

32. The CVT of claim 28, wherein the first end of the axle is spherical.

33. The CVT of claim 32, wherein a diameter of the first end of the axle is greater than a diameter of at least one pin.
